(19) United States
(12) Patent Application Publication
(10) Pub. No.: US 2025/0232157 A1
(43) Pub. Date: Jul. 17, 2025

(54) Determining A Distribution Function

(71) Applicant: Siemens Aktiengesellschaft, München (DE)

(72) Inventors: Aaron Haag, Mauer (DE); Oliver Lohse, Kirchseeon (DE)

(73) Assignee: Siemens Aktiengesellschaft, München (DE)

(21) Appl. No.: 19/020,110

(22) Filed: Jan. 14, 2025

(30) Foreign Application Priority Data
Jan. 15, 2024 (DE) 10 2024 200 335.2

(51) Int. Cl. G06N 3/047

(52) U.S. Cl. CPC G06N 3/047

(57) ABSTRACT

Teaching herein include methods for determining a statistical distribution function and for determining parameters for the distribution function, with which a time series of measurement data can be displayed. An example includes: determining a first probability for a predetermined quantity of statistical distribution functions for each function that the measurement data has a distribution corresponding to this distribution function; determining a second probability that the measurement data originates from a temporally stationary source; determining, for the predetermined quantity of distribution functions for each distribution function, an evaluation variable for the respective distribution function from the assigned first probability, a temporal changeability of the distribution function, and the second probability; using the evaluation variable to select a distribution function from the quantity of distribution functions as a suitable distribution function for the measurement data; and determining parameters for the display of the measurement data for the selected distribution function.

### CROSS-REFERENCE TO RELATED APPLICATIONS

This application claims priority to DE Application No. 10 2024 200 335.2 filed Jan. 15, 2024, the contents of which are hereby incorporated by reference in their entirety.

### TECHNICAL FIELD

The present disclosure relates to distribution functions. Various embodiments of the teachings herein include systems and/or methods for determining a distribution function and for determining parameters for the distribution function, with which a time series of measurement data can be described.

### BACKGROUND

For quality control using machine and capability analysis, measured values which relate to specific properties of the workpieces, for instance bore diameter or coarseness, are captured continuously during manufacture and assembly. That distribution function, which best describes the time series, is determined on the basis of the resulting time series of such a property.

The distribution function relates here to a type of statistical distribution, for instance a normal distribution or Weibull distribution. The distribution is described by a function term with defined parameters, for instance for the normal distribution:

$$f ( x ) = \frac{1}{σ \sqrt{2 π}} \cdot exp [ - \frac{1}{2} \cdot {( \frac{x - μ}{σ} )}^{2} ]$$

The parameters of the normal distribution are u (average value) and σ (standard deviation). As a result, the distribution function f(x) delivers the probability of the occurrence of this input value x for a specific input value x used. The distribution can be temporally stationary, temporally non-stationary or can be a mixed type, for instance temporally stationary in blocks. A temporally non-stationary distribution has parameters which are temporally not constant. For instance, the average value can be temporally changeable, in other words μ=μ(t).

To determine the distribution function, the class of the distribution function of the time series can firstly be estimated and its parameters can then be determined with the aid of maximum likelihood estimators or other algorithms. The distribution function is then used to determine the capability of the manufacturing and assembly process, respectively, for instance on the basis of the quantiles of the distribution function. A reliable statement about the ability depends on how well the estimated class of the distribution function matches with the actual behavior of the measured values.

In a known procedure, respective parameters which describe the measured values in the best possible way are determined for each known distribution function on the basis of the measured values. A goodness-of-fit test, for instance a Pearson's Chi square test, is subsequently carried out and that distribution function which has the highest goodness-of-fit is selected. This method requires a high computing capacitance, since the parameters of all known distributions have to be estimated. Here the temporal course of the parameters must be monitored by further estimators.

### SUMMARY

The teachings of the present disclosure specify methods for determining a distribution function and for determining parameters for the distribution function, with which the disadvantages described are reduced. In particular, the required computing capacity is to be decreased. For example, some embodiments include a method for determining a statistical distribution function and for determining parameters for the distribution function, with which a time series (101) of measurement data can be displayed, in which a first probability (165) is determined for a predetermined quantity of statistical distribution functions for each distribution function that the measurement data has a distribution corresponding to this distribution function, a second probability is determined that the measurement data originates from a temporally stationary source, for the predetermined quantity of distribution functions for each distribution function an evaluation variable for the respective distribution function is determined from the assigned first probability, from a temporal changeability of the distribution function and the second probability, the evaluation variable is used to select a distribution function from the quantity of distribution functions as a suitable distribution function for the measurement data, and parameters for the display of the measurement data are determined for the selected distribution function.

In some embodiments, the evaluation variable is determined for a distribution function in such a way that if the distribution function is a temporally non-stationary distribution function, its first probability is multiplied by the second probability in order to obtain evaluation variables, if the distribution function is a temporally stationary distribution function, its first probability is multiplied by the inverse second probability in order to obtain evaluation variables, and otherwise the first probability is used to obtain the evaluation variable.

In some embodiments, the second probability is determined using a first neural network (225).

In some embodiments, a measurement data vector is determined from the time series by means of scanning, the number of elements of which corresponds to the number of input nodes of the first neural network (225).

In some embodiments, the first neural network (225) is trained with a plurality of data records, of which a first part contains randomly determined values of a temporally stationary statistical distribution function and of which a second part contains randomly determined values of a temporally non-stationary distribution function.

In some embodiments, a kernel density estimation is carried out for the measurement data.

In some embodiments, the result of the kernel density estimation is used as an input variable for a second neural network, the output values of which are the first probabilities.

In some embodiments, the Scott bandwidth is used as a kernel density for the kernel density estimation.

In some embodiments, the parameter is determined with a maximum likelihood estimation.

In some embodiments, the measurement data is standardized before the processing.

In some embodiments, the result of the kernel density estimation is a data vector with a number of elements, which is the interval width between the smallest and largest measured value divided by a selected bandwidth and the number of input nodes of the second neural network corresponds to this number of elements.

In some embodiments, the number of the output nodes of the second neural network corresponds to the number of distribution functions in the predetermined quantity of distribution functions.

As another example, some embodiments include an apparatus for determining a statistical distribution function and determining parameters for the distribution function, with which a time series of measurement data can be displayed, is designed to carry out one or more of the methods as described herein.

### BRIEF DESCRIPTION OF THE DRAWINGS

The teachings herein are described and explained in more detail below with the aid of the exemplary embodiments shown in the figures, in which:

FIG. 1 is a drawing showing a schematic representation of the determination of a first data record from a time series of measurement data incorporating teachings of the present disclosure;

FIG. 2 is a drawing showing a schematic representation of the determination of a second data record from the time series of measurement data incorporating teachings of the present disclosure; and

FIG. 3 is a drawing showing a schematic representation of the selection of a distribution function from the first and second data record incorporating teachings of the present disclosure.

### DETAILED DESCRIPTION

The methods and systems described herein may be used to determine a statistical distribution function and to determine parameters for this distribution function, wherein a time series of measurement data can be displayed with the distribution function and the parameters thus determined. The term “can be displayed” is understood here to mean that the occurrence of measurement data statistically has a good match with the prediction by means of the distribution function. Since the measurement data only concerns a finite quantity of values, this match cannot be mathematically limited exactly. Depending on the nature and quantity of the measurement data, this can therefore also be similarly well displayed by different distribution functions. Parameters of the distribution function are understood to mean those fixed numerical values or time-dependent numerical values which have to be defined so that the distribution function is still only dependent on x or in the case of the time dependent distribution function additionally on the time t, but otherwise has no unknowns.

With the method, a first probability is determined for a predetermined quantity of statistical distribution functions for each distribution function that the measurement data has a distribution according to this distribution function.

Furthermore, a second probability is determined that the measurement data originates from a temporally stationary source. A temporally stationary source is understood to mean that the distribution of the measurement data is not subject to any temporal change even if each value of the measurement data is itself subject to the statistical distribution. In other words, a recording of measurement data would not produce the same measurement data at different times since this is statistically distributed, however, with an adequate number of measurement data, it is not possible to determine any difference between its statistical distribution.

It is apparent that the two probabilities each assume values of 0 to 1. Furthermore, an evaluation variable for the respective distribution function is determined for each distribution function from the predetermined quantity of distribution functions from the assigned first probability, from a temporal changeability of the distribution function itself and the second probability.

Finally, a distribution function is selected from the quantity of distribution functions as a suitable distribution function for the measurement data on the basis of the evaluation variable. Parameters to display the measurement data are then determined for the selected distribution function.

The inventive apparatus for determining a statistical distribution function and for determining parameters for the distribution function, with which a time series of measurement data can be displayed, is designed to carry out the inventive method.

The quantity of distribution functions can comprise the normal distribution, logarithmic normal distribution, amount distribution of a first type, Weibull distribution and Rayleigh distribution, for instance. Furthermore, the quantity can also contain defined mixtures from the forecited and other distributions.

The following procedure may be used to determine the evaluation variable: If the distribution function is a temporally non-stationary distribution function, its first probability is multiplied by the second probability in order to obtain the evaluation variable. The evaluation variable is expediently the product of the first and second probability.

If the distribution function is a temporally stationary distribution function, its first probability is multiplied by the inverse second probability in order to obtain the evaluation variable. The evaluation variable is in this case expediently the product of the first and inverse second probability. The inverse second probability p₂ᵢₙᵥ with respect to the second probability p₂ is p₂ᵢₙᵥ=1−p₂.

Otherwise, the first probability is used to obtain the evaluation variable. In this case the evaluation variable is expediently the first probability.

In some embodiments, the second probability may be determined using a first neural network. Here the neural network can be trained relatively easily on the basis of distributions produced artificially and then efficiently provides a result without having to develop a specific algorithm herefor. It is apparent that the neural network is an artificial, computer-implemented network.

A measurement data vector may be determined from the time series by means of scanning, the number of elements of which corresponds to the number of input nodes of the first neural network. As a result, the quantity of measurement data is adjusted to the conditions of the first neural network and the neural network itself thus need not be configured so that it can manage with a variable number measurement data. This significantly simplifies the creation of the first neural network.

In some embodiments, a training of the first neural network is performed with a plurality of data records, of which a first part contains randomly determined values of a temporally stationary distribution function and of which a second part contains randomly determined values of a temporally non-stationary distribution function. All distribution functions from the predetermined quantity of distribution functions are expediently used and plurality of data records is generated. Temporally non-stationary distribution functions contain time-dependent parameters, for instance a temporally changeable average value. Temporally stationary distribution functions only contain fixed parameters (numbers) and its function thus contains the input value x as the sole variable.

A kernel density estimation may be carried out for the measurement data. The result of the kernel density estimation may be used as an input variable for a second neural network, the output values of which are the first probabilities. The Scott bandwidth can be used as the kernel density for the kernel density estimation. The result of the kernel density estimation may be a data vector with a number of elements, which is the interval width between the smallest and largest measured value divided by a selected bandwidth. In some embodiments, the number of input nodes of the second neural network corresponds to this number of elements. In this way a significant simplification is achieved again for the design of the second neural network.

In some embodiments, the number of output nodes of the second neural network corresponds to the number of distribution functions predetermined quantity of distribution functions. As a result, the output of the second neural network can be interpreted directly with respect of the quantity of the distribution functions.

A maximum likelihood estimation can be performed for the determination of the parameters. The measurement data may be standardized before the processing, for instance in the interval [0, 1]. This ensures that the neural networks also only have to be designed and trained for handling with measured values in this interval, as a result of which the design of the neural network is simplified.

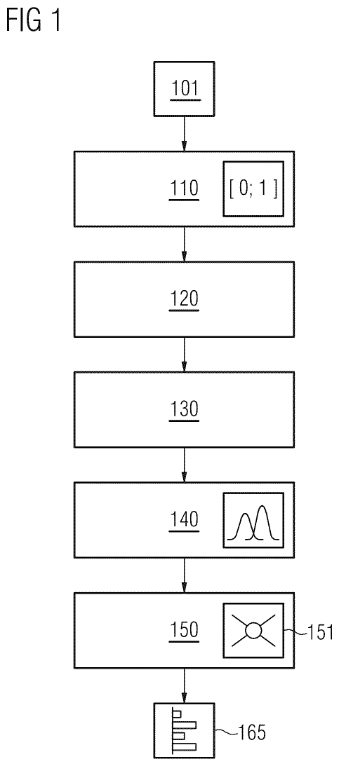

FIG. 1 is a drawing showing a schematic representation of the determination of a first data record 165 from a time series 101 of measured values mi. The time series 101 here is an input variable for the method and is provided by way of example by a sensor in a machine, for instance a pressure sensor or a tachometer.

In a first step 110, the time series 101 of measured values mi is standardized. In this step, the measured values mᵢ are modified so that they all fall in the value range [0, 1]. To this end, a maximum and a minimum measured value mₘₐₓ and mₘᵢₙ are determined and from this the average value mₘ=(mₘₐₓ+mₘᵢₙ)/2 is formed. m_{norm,i}=2. (mᵢ−mₘ)/(mₘₐₓ−mₘᵢₙ) is formed as a standardized measured value for each measured value. In certain cases, for instance with measured values which naturally have upper or lower limits, a different type of standardization can be considered.

In a second step 120, the Scott bandwidth s_{bw} is determined for the standardized measurement data m_{norm, i} according to:

$$h = \frac{3.49 σ}{\sqrt[3]{n}}$$

Here σ is the standard deviation of the measurement data m_{norm, i} and n is the number of measurement data m_{norm,i}. This is used in a third step 130, in order to determine the position of a fixed number of N_{K} base values.

In a fourth step 140, a kernel density estimation is performed for the N_{K} base values. In the result N_{K} this achieves values for the respective density. These values are fed to a second neural network 151 as input values in a fifth step 150. The second neural network 151 has precisely N_{K} input nodes for this purpose. The number of N_{K} values is therefore used similarly for each time series of measurement data.

The second neural network 151 is trained to generate an estimation for all distribution functions of a predetermined quantity of distribution functions from the input data with regards to the probability with which the time series 101 can be described by a respective distribution function or in other words how well the input data matches the distribution function. The output values of the second neural network 151 are therefore a first data record with k first probabilities p_{1,i}, wherein p_{1,i} specifies the probability with which the i-th distribution function effectively describes the process which forms the basis of the measurement data mᵢ.

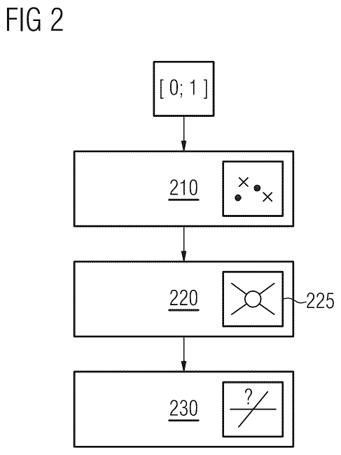

The first data record 165 thus obtained is subsequently processed together with a second item of information which is determined in a method illustrated in FIG. 2. The method begins with the set of standardized measured values m_{norm,i}, which is determined in the first step 110 according to FIG. 1. The method shown in FIG. 2 therefore connects to the first step 110.

In a first step 210, a resampling/downsampling of the standardized measured values m_{norm,i} is performed. This is carried out so that a vector 215 with a fixedly predetermined number Nm of standardized variables m_{norm,i} ultimately remains. The fixedly predetermined number Nm can be larger or smaller here than the actually available number of measured values m_{norm, i}.

The vector 215 thus obtained is supplied to a first neural network 225 in a second step 220. The first neural network 225 has precisely Nₘ input nodes, to which in each case one of the values of the vector 215 is supplied as an input value. The first neural network 225 is designed so that as a result it supplies an estimate to determine whether the measured values m_{norm, i}, which exist as input values on the input nodes, originate from a temporally stationary or a temporally non-stationary distribution function.

The first neural network 225 has two output nodes herefor, of which one first specifies a value o₁ for the probability of a temporally stationary distribution function and the second output node specifies a value o₂ of the probability of a temporally non-stationary distribution function. A true probability pₛₜₐₜ for a stationary distribution can be determined from the two values, which added together do not necessarily produce 1, on the basis of Pₛₜₐₜ=o₁/(o₁+o₂). The probability Pₙₒₙₛₜₐₜ for the existence of a non-stationary distribution is the inverse probability relating to pₛₜₐₜ, in other words pₙₒₙₛₜₐₜ=1−Pₛₜₐₜ=o₂/(o₁+o₂).

In some embodiments, the first neural network 225 can also have an individual output node, which directly specifies the probability of a stationary distribution pₛₜₐₜ, for instance.

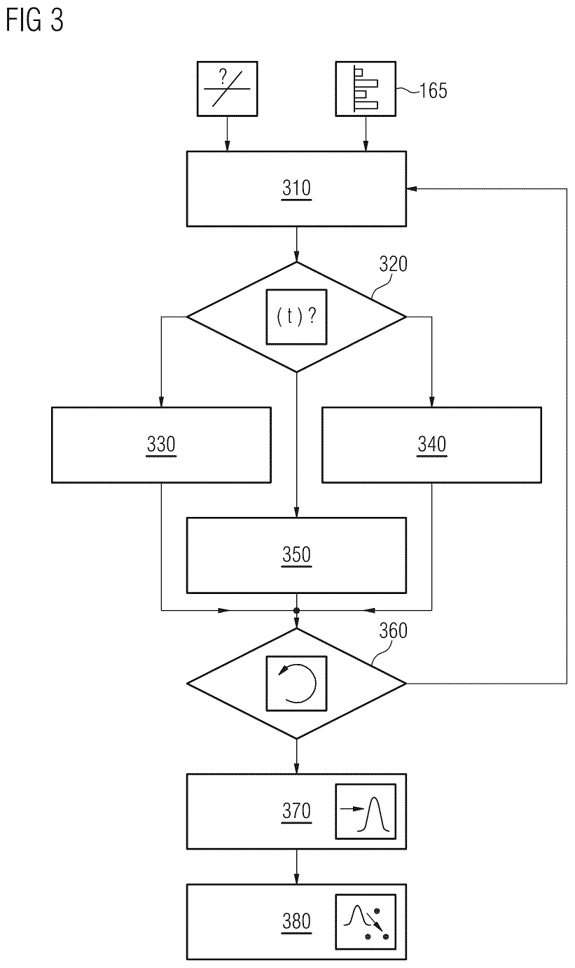

The first data record determined and the probability of a stationary distribution pₛₜₐₜ (and/or pₙₒₙₛₜₐₜ) are further used in a method which is shown schematically in FIG. 3.

In the method illustrated in FIG. 3, as in the method of FIG. 1, all distribution functions of the predetermined quantity of distribution functions are considered.

In a first step 310, a previously not yet considered (first or next) distribution function fᵢ(x); i=1 . . . . N_{V} is used from the quantity of the distribution functions. For this a query is made in a second step 320 to determine whether it is temporally stationary, temporally non-stationary or a mixed type. This information is already permanently stored for each distribution function in the quantity of distribution functions, but can also be retrieved directly.

If the currently considered distribution function fᵢ(x) is temporally stationary, in a third step 330 the first probability value p_{1,i}, which has been determined in the method according to FIG. 1 for this distribution function and is part of the first data record, is multiplied by the probability determined in the method according to FIG. 2 which specifies that the measured values originate from a temporally stationary source (pₛₜₐₜ). The value thus obtained is an evaluation variable wᵢ=Pₛₜₐₜ·P_{1,i} for this distribution function.

If by contrast the currently considered distribution function fᵢ(x) is temporally non-stationary, in a fourth step 340 the first probability value p_{1,i} is multiplied by the probability determined in the method according to FIG. 2, which specifies that the measured values originate from a temporally non-stationary source (pₙₒₙₛₜₐₜ=1−Pₛₜₐₜ). The value thus obtained is again the evaluation variable wᵢ=Pₙₒₙₛₜₐₜ·p_{1,i}=(1−Pₛₜₐₜ)·p_{1,i} for this distribution function.

If the currently considered distribution function fᵢ(x) is finally a mixed form, for instance temporally stationary in blocks, then in the fifth step 350 no further modification is performed for the first probability value p_{1,i} and the evaluation variable corresponds directly with the first probability value, wᵢ=P_{1,i}.

In a sixth step 360, a check is performed to determine whether all distribution functions have already been considered from the quantity of distribution functions. If this is not the case, a move is made back to the first step 310 and the next distribution function is considered.

If an evaluation variable wᵢ is determined for all distribution functions fᵢ(x), then that distribution function fa (x) which has the largest evaluation variable, Wₐ=max(wᵢ) is selected in a seventh step 370.

The thus selected distribution function fa (x) is considered as the distribution function in the procedure described here, said distribution function best describing the measurement data mᵢ. In order to establish the specific connection with the measurement data mᵢ, the parameters of the distribution function fₐ(x) are now determined in an eighth step 380. This occurs in the present example with a maximum likelihood estimation. The parameters are advantageously therefore only determined for the selected distribution function fₐ(x) and not for all distribution functions.

### REFERENCE CHARACTERS

101 Time series of measured values
165 First data record
110-150 Steps
151 Second neural network
210-230 Steps
215 Vector of standardized measured values
225 First neural network
310-380 Steps

What is claimed is:

1. A method for determining a statistical distribution function and for determining parameters for the distribution function, with which a time series of measurement data can be displayed, the method comprising:
determining a first probability for a predetermined quantity of statistical distribution functions for each distribution function that the measurement data has a distribution corresponding to this distribution function;
determining a second probability that the measurement data originates from a temporally stationary source;
determining, for the predetermined quantity of distribution functions for each distribution function, an evaluation variable for the respective distribution function from the assigned first probability, a temporal changeability of the distribution function, and the second probability;
using the evaluation variable to select a distribution function from the quantity of distribution functions as a suitable distribution function for the measurement data; and
determining parameters for the display of the measurement data for the selected distribution function.

2. The method as claimed in claim 1, wherein determining the evaluation variable for a distribution function includes:
if the distribution function is a temporally non-stationary distribution function, its first probability is multiplied by the second probability in order to obtain evaluation variables;
if the distribution function is a temporally stationary distribution function, its first probability is multiplied by the inverse second probability in order to obtain evaluation variables; and
otherwise the first probability is used to obtain the evaluation variable.

3. The method as claimed in claim 1, wherein the second probability is determined using a first neural network.

4. The method as claimed in claim 1, further comprising determining a measurement data vector from the time series by means of scanning, the number of elements of which corresponds to the number of input nodes of a first neural network.

5. The method as claimed in claim 1, wherein a first neural network is trained with a plurality of data records, of which a first part contains randomly determined values of a temporally stationary statistical distribution function and of which a second part contains randomly determined values of a temporally non-stationary distribution function.

6. The method as claimed in claim 1, further comprising Carrying out a kernel density estimation for the measurement data.

7. The method as claimed in claim 6, wherein the result of the kernel density estimation is used as an input variable for a second neural network, the output values of which are the first probabilities.

8. The method as claimed in claim 6, wherein the Scott bandwidth is used as a kernel density for the kernel density estimation.

9. The method as claimed in claim 1, wherein the parameter is determined with a maximum likelihood estimation.

10. The method as claimed in claim 1, wherein the measurement data is standardized before the processing.

11. The method as claimed in claim 1, wherein the result of the kernel density estimation is a data vector with a number of elements, which is the interval width between the smallest and largest measured value divided by a selected bandwidth and the number of input nodes of the second neural network corresponds to this number of elements.

12. The method as claimed in claim 1, wherein the number of the output nodes of the second neural network corresponds to the number of distribution functions in the predetermined quantity of distribution functions.

13. (canceled)
